(19) United States
(12) Patent Application Publication
(10) Pub. No.: US 2002/0103628 A1
(43) Pub. Date: Aug. 1, 2002

(54) System, method and storage medium for providing thermal feasibility analysis

(76) Inventors: Scott J. Leslie, Pittsfield, MA (US); Robert McKay, Pittsfield, MA (US)

Correspondence Address: CANTOR COLBURN, LLP, 55 GRIFFIN ROAD SOUTH, BLOOMFIELD, CT, 06002

(21) Appl. No.: 09/682,347

(22) Filed: Aug. 23, 2001

Related U.S. Application Data
(60) Provisional application No. 60/265,294, filed on Jan. 31, 2001.

(51) Int. Cl. G06F 17/50

(52) U.S. Cl. 703/1

(57) ABSTRACT

An embodiment of the invention is a method for performing thermal feasibility analysis for an enclosure containing electronics. The method includes obtaining design parameters related to the enclosure. A thermal feasibility analysis is performed for a plurality of enclosure designs in response to the design parameters. The enclosure designs vary in enclosure material, mounting location of the electronics and presence of a heat sink. The results of the thermal feasibility analysis are displayed for the plurality of enclosure designs.

### CROSS REFERENCE TO RELATED APPLICATIONS

This application claims the benefit of U.S. provisional patent application Ser. No. 60/265,294 filed Jan. 31, 2001, the entire contents of which are incorporated herein by reference.

### BACKGROUND OF INVENTION

Thermal feasibility analysis is a technique used to determine if a product design can meet certain thermal requirements. In the field of enclosures for electronic devices, thermal feasibility analysis may be performed to evaluate whether temperature limits of the electronics will be met. Such analysis indicates whether the enclosure volume, electronics placement, enclosure materials and heat sink area are sufficient to meet the temperature requirements of the electronics. A challenge in designing suitable enclosures is determining what materials may be used for the enclosure and how material selection affects thermal feasibility.

### SUMMARY OF INVENTION

An embodiment of the invention is a method for performing thermal feasibility analysis for an enclosure containing electronics. The method includes obtaining design parameters related to the enclosure. A thermal feasibility analysis is performed for a plurality of enclosure designs in response to the design parameters. The enclosure designs vary in enclosure material, mounting location of the electronics and presence of a heat sink. The results of the thermal feasibility analysis are displayed for the plurality of enclosure designs.

### BRIEF DESCRIPTION OF DRAWINGS

Referring now to the drawings wherein like elements are numbered alike in several FIGURES:

FIG. 1 is a block diagram of a system for providing thermal feasibility analysis;

FIG. 2 is an exemplary user interface;

FIG. 3 is an exemplary user interface depicting electronics temperature for multiple enclosure designs;

FIG. 4 is an exemplary user interface depicting electronics temperature for multiple enclosure designs; and

FIG. 5 is an exemplary user interface depicting enclosure temperature for multiple enclosure designs.

### DETAILED DESCRIPTION

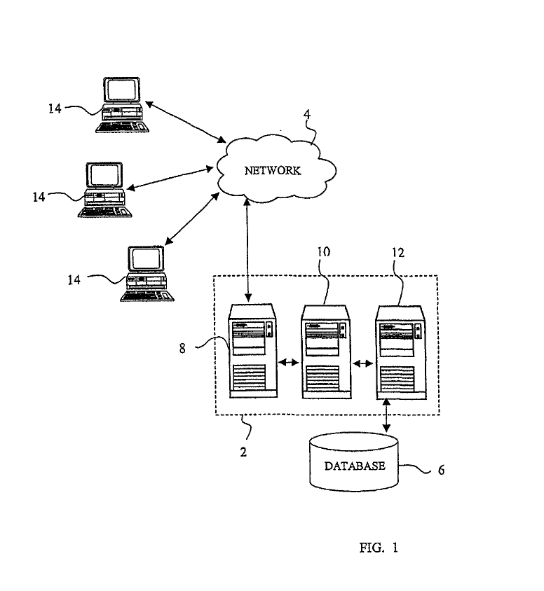

FIG. 1 is a block diagram of an exemplary system for providing thermal feasibility analysis in one embodiment. The system includes a host system 2 and a network 4. One or more user systems 14 may be coupled to the host system 2 via the network 4. Each user system 14 may be implemented using a general-purpose computer executing a computer program for carrying out processes described herein. The network 4 may be any type of known network including a local area network (LAN), wide area network (WAN), global network (e.g., Internet), intranet, etc. Each user system 14 and the host system 2 may be connected to the network 4 in a wireless fashion and network 4 may be a wireless network. In one embodiment, the network 4 is the Internet and each user system 14 executes a user interface application (e.g., web browser) to contact the host system 2 through the network 4. Alternatively, the user system 14 may be implemented using a device programmed primarily for accessing network 4 such as a network computer.

The host system 2 may include one or more servers. In one embodiment, a network server 8 (often referred to as a web server) may communicate with the user systems 14. The network server 8 may be implemented using commercially available servers as are known in the art. The network server 8 handles sending and receiving information to and from user systems 14 and can perform associated tasks. The host system 2 may also include a firewall server 10 to: (a) prevent unauthorized access to the host system 2; and (b) with respect to individuals/companies that are authorized access to the host system 2, enforce any limitations on the authorized access. For instance, a system administrator typically may have access to the entire system and have authority to update portions of the system. By contrast, a user contacting the host system 2 from a user system 14 would have access to use applications provided by applications server 12 but not alter the applications or data stored in database 6. The firewall server 10 may be implemented using conventional hardware and/or software as is known in the art.

The host system 2 may include an applications server 12. Applications server 12 may execute one or more software applications that analyze thermal characteristics of a variety of enclosure designs. The applications server 12 may be coupled to a database 6. Database 6 may contain a variety of information used by the applications server 12. Such information may include thermal feasibility analysis data such as material properties for metal and plastic, thermal transfer functions, etc. It is understood that a single server may used to provide the functions of the web server, firewall server and applications server.

In an exemplary embodiment, the system is directed to aiding customers in the evaluation of thermal characteristics of different enclosure designs, and in particular, the evaluation of aluminum enclosures versus plastic enclosures. The operator of the host system 2 may be a plastics supplier desirous of educating potential customers of the availability of plastic enclosures as opposed to metal enclosures.

Operation of the system will now be described. In an exemplary embodiment, the user system 14 includes a user interface application (e.g., a web browser), which allows the user system 14 to contact the host system 2 via network 4 (e.g., the Internet). In one embodiment, once the user system 14 contacts the host system 2, the host system 2 may require the user to log in by providing a user ID and password. This confirms that the user is permitted to access the host system 2 and provides control on the level of access (e.g., existing customer versus potential new customer).

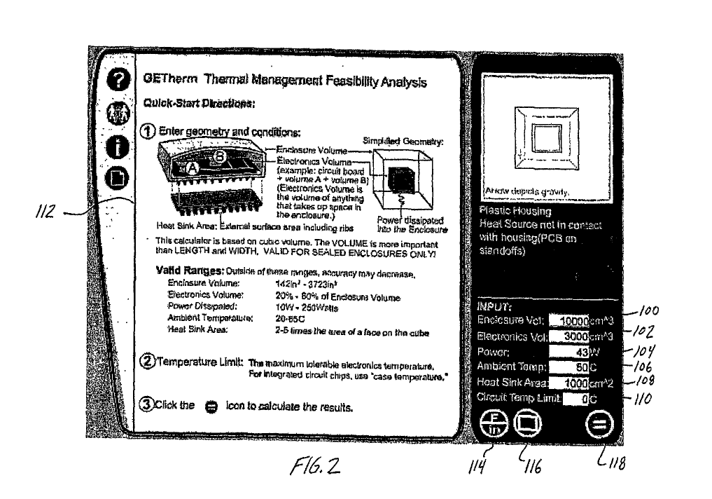

The user system 14 is initially presented with a main user interface such as that shown in FIG. 2. The main user interface includes a number of design parameter fields 100-110 through which the user can enter design parameters used in the thermal feasibility analysis. The enclosure volume field 100 allows the user to enter the volume of the enclosure to be analyzed. The electronics volume field 102 allows the user to enter the volume of the electronics contained in the enclosure. The power field 104 allows the user to enter the total power dissipated by the electronics. The ambient temperature field 106 allows the user to enter the ambient temperature of the medium (e.g., air) surrounding the enclosure. The heat sink area field 108 allows the user to enter the external area for a heat sink. Lastly, the circuit temperature limit field 110 allows the user to enter the maximum temperature limit for the electronics in the enclosure.

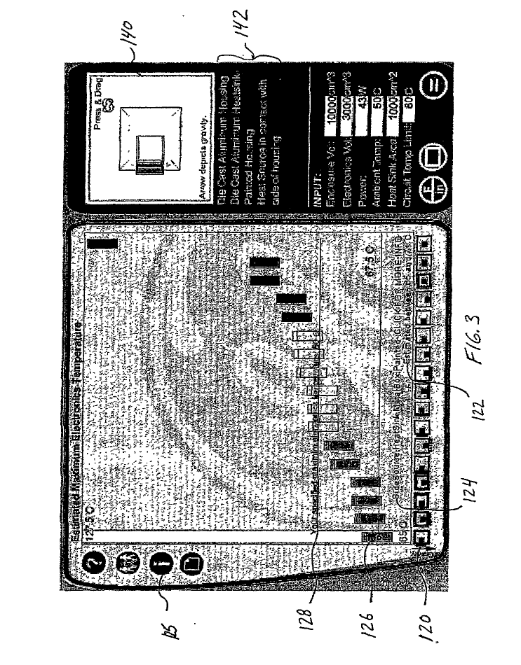

An instructional window 112 is presented to describe how each field 100-110 is to be populated. Also, a description of each field may be presented to the user upon selection of a field through an input peripheral (e.g., a mouse). A units icon 114 allows the user to enter design parameters in fields 100-110 in English or metric units. An electronics/enclosure icon 116 allows the user to view electronics temperature or enclosure temperature for a variety of enclosure designs as described herein with reference to FIGS. 3-5. Once the user has populated fields 100-110, the user selects a calculate icon 118 to initiate the analysis.

The analysis is performed by the applications server 12 and the results are presented to the user system 14. FIG. 3 depicts exemplary results of an analysis. The results include a graphical depiction 120 of a number of enclosure designs. Each graphical depiction represents the enclosure type (e.g., plastic, metal, painted metal) by graphical indicia (colors, texture, etc). The location of the heat source (i.e., electronics) is graphically depicted within the graphical depiction of the enclosure type. Also, the presence and location of any heat sink is graphically depicted.

In addition to the graphical depiction of the enclosure designs, a textual description 124 may be provided for a selected enclosure design (in FIG. 3, the first enclosure design is selected). The user selects an enclosure design by clicking, for example, on a graphical representation 120. The textual description 124 indicates the location of the heat source, the presence of a heat sink and the enclosure type. Presented above each graphical depiction 120 is a calculated temperature range 126 for that enclosure design. The applications server 12 computes temperature values for the electronics for each enclosure design based on existing transfer functions and the design parameters entered through design parameter fields 100-110. The low and high temperature values define the temperature range 126, based upon comparison of the calculated values to test data. A textual description 122 of the calculated temperature range is also provided for the selected enclosure design. A temperature limit 128 is also graphically depicted and corresponds to the temperature limit entered through temperature limit field 110.

As shown in FIG. 3, enclosure designs having an electronics temperature range below the electronics temperature limit 128 are depicted in a first manner (e.g., colored green). Enclosure designs having an electronics temperature range containing the electronics temperature limit 128 are depicted in a second manner (e.g., colored yellow). Enclosure designs having an electronics temperature range exceeding the electronics temperature limit 128 are depicted in a third manner (e.g., colored red). This format allows the user to quickly evaluate which enclosure designs are feasible based upon the temperature limit 128. An information icon 125 can be used to get help in interpreting the results to help determine the feasibility of a given design configuration.

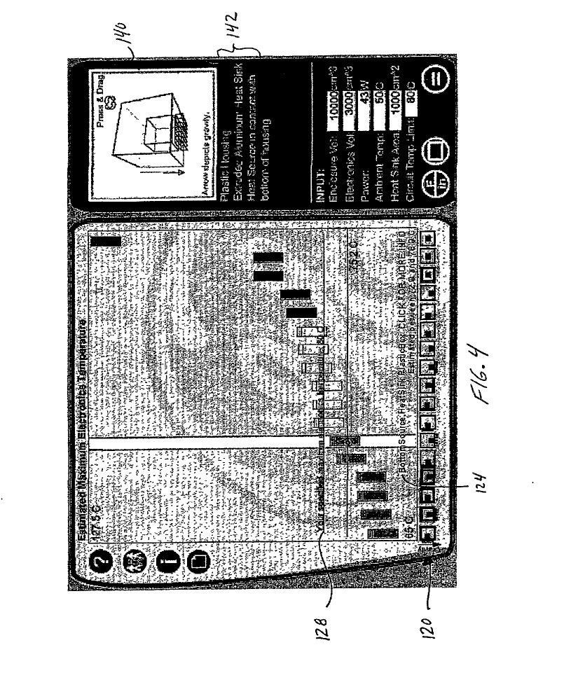

A design window presents a three-dimensional representation 140 of the selected enclosure design depicting the location of the electronics and any heat sink if used. The three dimensional representation of the enclosure design may be rotated about all three axis through an input peripheral such as a mouse. A textual description 142 of the selected enclosure design is also provided. FIG. 4 illustrates selection of another enclosure design 120. The three dimensional representation 140 and the text description 142 are updated to correspond to the selected enclosure design.

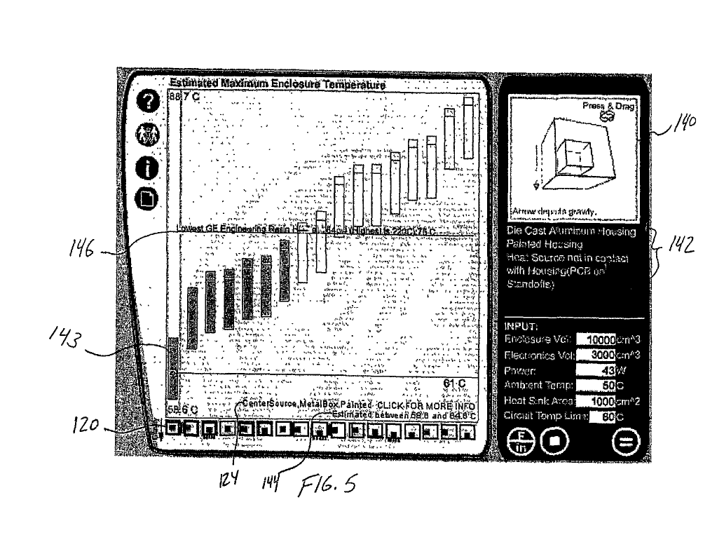

The enclosure/electronics icon 116 allows a user to switch between a plot of electronics temperature as shown in FIGS. 3 and 4 and a plot of enclosure temperature as shown in FIG. 5. The applications server 12 computes the enclosure temperature based on predetermined transfer functions and design parameters entered in design parameter fields 100-110. The interface shown in FIG. 5 includes a graphical representation of the enclosure designs 120, a textual description of the enclosure designs 124, graphical enclosure temperature range 143 and a textual description of the enclosure temperature range 144. Also presented is a heat deflection temperature, representing a low value for engineering thermoplastics 146. The heat deflection temperature is a relative value that represents the temperature at which a plastic plaque deforms a given amount under a given load. The heat deflection temperature is useful in comparing two different plastic materials. Since material selection based on heat deflection temperature requires both a temperature and a mechanical load, the temperature predictions from this tool can be used as an input for structural analysis. Enclosure designs having an enclosure temperature range below the heat deflection temperature 146 may be depicted in a first manner (e.g., colored green). Enclosure designs having an enclosure temperature range containing or above the heat deflection temperature 146 may be depicted in a second manner (e.g., colored yellow). As described with reference to FIGS. 3 and 4, the user can select different enclosure designs and view information concerning the design in three-dimensional representation 140 and/or the textual description 142 of the enclosure design.

The description applying the above embodiments is merely illustrative. As described above, embodiments in the form of computer-implemented processes and apparatuses for practicing those processes may be included. Also included may be embodiments in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Also included may be embodiments in the form of computer program code, for example, whether stored in a storage medium, loaded into and/or executed by a computer, or as a data signal transmitted, whether a modulated carrier wave or not, over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

1. A method for performing thermal feasibility analysis for an enclosure containing electronics, the method comprising:
obtaining design parameters related to the enclosure;
performing a thermal feasibility analysis for a plurality of enclosure designs in response to said design parameters, said enclosure designs varying in enclosure material, mounting location of the electronics and presence of a heat sink;
said enclosure material including plastic;
displaying results of the thermal feasibility analysis for said plurality of enclosure designs.

2. The method of claim 1 wherein said thermal feasibility analysis includes an electronics temperature range for each enclosure design.

3. The method of claim 2 wherein said displaying includes displaying the electronics temperature range for each enclosure design.

4. The method of claim 3 wherein said electronics temperature range for each enclosure design is displayed graphically relative to a user-defined electronics temperature limit.

5. The method of claim 4 wherein said electronics temperature range for each enclosure design is displayed in varying colors in response to a positional relationship between said electronics temperature range and said user-defined electronics temperature limit.

6. The method of claim 2 wherein said displaying includes graphically depicting said enclosure material, mounting location of the electronics and presence of the heat sink.

7. The method of claim 2 wherein said displaying includes textually describing said enclosure material, mounting location of the electronics and presence of the heat sink.

8. The method of claim 1 wherein said thermal feasibility analysis includes an enclosure temperature range for each enclosure design.

9. The method of claim 8 wherein said displaying includes displaying the enclosure temperature range for each enclosure design.

10. The method of claim 9 wherein said enclosure temperature range for each enclosure design is displayed graphically relative to a material temperature limit.

11. The method of claim 10 wherein said enclosure temperature range for each enclosure design is displayed in varying colors in response to a positional relationship between said enclosure temperature range and said material temperature limit.

12. The method of claim 10 wherein said material temperature limit is a heat deflection temperature for a plastic.

13. The method of claim 9 wherein said displaying includes graphically depicting said enclosure material, mounting location of the electronics and presence of the heat sink.

14. The method of claim 9 wherein said displaying includes textually describing said enclosure material, mounting location of the electronics and presence of the heat sink.

15. The method of claim 1 wherein said design parameters include enclosure volume, electronics volume, electronics power, ambient temperature and heat sink area.

16. A method for performing thermal feasibility analysis for an enclosure containing electronics, the method comprising:
obtaining design parameters related to the enclosure;
performing a thermal feasibility analysis for a plurality of enclosure designs in response to said design parameters, said enclosure designs varying in enclosure material, mounting location of the electronics and presence of a heat sink;
said enclosure material including plastic and metal;
displaying results of the thermal feasibility analysis for said plurality of enclosure designs;
wherein said thermal feasibility analysis includes an electronics temperature range for each enclosure design, said displaying including displaying the electronics temperature range for each enclosure design graphically relative to a user-defined electronics temperature limit; and,
wherein said thermal feasibility analysis includes an enclosure temperature range for each enclosure design, said displaying including displaying the enclosure temperature range for each enclosure design graphically relative to a material temperature limit.

17. A system for performing thermal feasibility analysis for an enclosure containing electronics, the system comprising:
a host system coupled to a network;
a database coupled to said host system, said database including thermal feasibility analysis data;
said host system receiving design parameters related to the enclosure over said network;
said host system performing a thermal feasibility analysis for a plurality of enclosure designs in response to said design parameters and said thermal feasibility data, said enclosure designs varying in enclosure material, mounting location of the electronics and presence of a heat sink, said enclosure material including plastic;
said host system providing results of the thermal feasibility analysis for said plurality of enclosure designs to user systems coupled to said network.

18. A storage medium encoded with machine-readable computer program code for performing thermal feasibility analysis for an enclosure containing electronics in a system including a host system, a database coupled to the host system and a user system coupled to the host system by a network, the storage medium including instructions for causing the host system to implement a method comprising:
obtaining design parameters related to the enclosure from the user system;
performing a thermal feasibility analysis for a plurality of enclosure designs in response to said design parameters, said enclosure designs varying in enclosure material, mounting location of the electronics and presence of a heat sink, said enclosure material including plastic;
providing results of the thermal feasibility analysis for said plurality of enclosure designs to the user system.
